(19) United States
(12) Patent Application Publication
(10) Pub. No.: US 2010/0164229 A1
(43) Pub. Date: Jul. 1, 2010

(54) Wave generating system for converting ocean waves into usable energy

(76) Inventor: John Lawson, Daly City, CA (US)

Correspondence Address: LAW OFFICES OF ANDREW SCHROEDER, P.O. Box 6731, Santa Maria, CA, 93454, US

(21) Appl. No.: 12/317,941

(22) Filed: Dec. 31, 2008

(51) Int. Cl. F03B 13/18

(52) U.S. Cl. 290/53

(57) ABSTRACT

A Wave Generating System for Converting Ocean Waves into Usable Energy includes a Base, a Polyp, and a Stem. The Polyp is connected to the Stem. The Stem is connected to the Base. In some preferred embodiments the Base may require a mooring design to counter both the upward force and a tendency to tip, which can release gas.

The Base is comprised of a plurality of first chamber, a second chamber, and a third chamber. In some preferred embodiments, the first chamber may be used to store Hydrogen, the second chamber may be used to store Oxygen, and the third chamber may be used to store breathable air for operators. The third chamber is also used for the purpose of imparting buoyancy to the Base.

### FIELD OF THE INVENTION

The present invention is in the area of renewable energy systems.

### BACKGROUND OF THE INVENTION

Many renewable sources of energy currently in development have been prompted by concerns over the rapidly decreasing reserves of oil, carbon emissions, and the volatile price fluctuations of various energy commodities. Although many of these renewable sources of energy show great promise and potential, they have hitherto been insufficient at displacing carbon-based fuels as the primary source of energy for much of the world.

One of the most fundamental deficiencies with most renewable sources of energy is the fact that they are not cost-competitive with most carbon-based fuels. As such, renewable sources of energy will continue to be marginalized until their cost effectiveness increases relative to the cost of carbon-based fuels.

For instance, with respect to solar energy, the efficacy of solar power is circumscribed by the amount of sunshine available during the day. In other words, it is not possible to harness enough energy at night time or during days with overcast weather. Another shortcoming of solar power is low voltage output of photovoltaic panels. Moreover, a closely related dilemma is the fact that power provided to the electrical grid must be used instantly and is typically not stored. And issue compounding the problem is the fact transmission loss due to line resistance will only further lessen the yield of energy output from many renewable “green sources” of energy.

The cost-effectiveness of many renewable sources of energy can be improved by improving the yield of energy as well as decreasing loss of potential energy. By way of example, electrical transmission through power lines results in a substantial loss of energy through the mere distribution of transferring that energy from one point to another.

One method of reducing the loss output of energy production and simultaneously increasing the yield of energy production is through an improved distribution system. For example, gases can be moved from one area to another with virtually no loss of energy in the process. Since the laws of physics dictate that gases or substances will inexorably travel from an area of high concentration to an area of low concentration, this movement of gases can take place with minimal cost.

For these reasons, it would be desirable to create a wave generator which generates hydrogen and oxygen in the ocean. These partitioned gases can be subsequently transferred to shore where the resulting gases can be used to create energy. In some cases, these gases may be used by cargo industries for the purpose of creating a clean source of energy for the purpose of moving cargo containers in various shipyards. And unlike the electrical grid with its inherent energy loss due to transmission loss due to wire resistance, such a system would take place with minimal loss of energy through the transmission or distribution of gases.

Therefore, what is clearly needed in the art is a system which is cost-competitive with carbon-based fuels which can be used for the purpose of providing inexpensive industry to various cargo distribution industries.

### SUMMARY OF THE INVENTION

It is an object of the present invention to provide a system for the purpose of providing inexpensive energy in the form of gases such as hydrogen and oxygen.

It is an object of the present invention to provide a system for the purpose of supplying inexpensive energy to various cargo distribution industries. The present invention can be used in conjunction with a transportation system capable of moving containerized cargo many miles inland. The resulting transportation system would impart minimal or no carbon-based emissions with minimum impact to environment.

It is an object of the present invention to provide a system for the purpose of supplying inexpensive energy to various sea-based data centers for the purpose of cooling servers.

### BRIEF DESCRIPTION OF THE DRAWING FIGURES

FIG. 1 is a side view of a preferred embodiment of the present invention.

FIG. 2 is a side view of a preferred embodiment of the present invention.

FIG. 3 is a side view of a preferred embodiment of the present invention.

FIG. 4 is a side view of a preferred embodiment of the present invention.

FIG. 5 is a rear view of a preferred embodiment of the present invention.

FIG. 6 is a plan view of a preferred embodiment of the present invention.

FIG. 7 is a plan view of a preferred embodiment of the present invention.

FIG. 8 is a side view of a preferred embodiment of the present invention.

FIG. 9 is a perspective view of a preferred embodiment of the present invention.

FIG. 10 is a perspective view of a preferred embodiment of the present invention.

FIG. 11 is a perspective view of a preferred embodiment of the present invention.

### DESCRIPTION OF PREFERRED EMBODIMENTS

According to a preferred embodiment of the present invention, a unique system is employed to use wave motion from swells in oceans or seas to generate Oxygen and Hydrogen through the process of electrolysis. The present invention is described in enabling detail below.

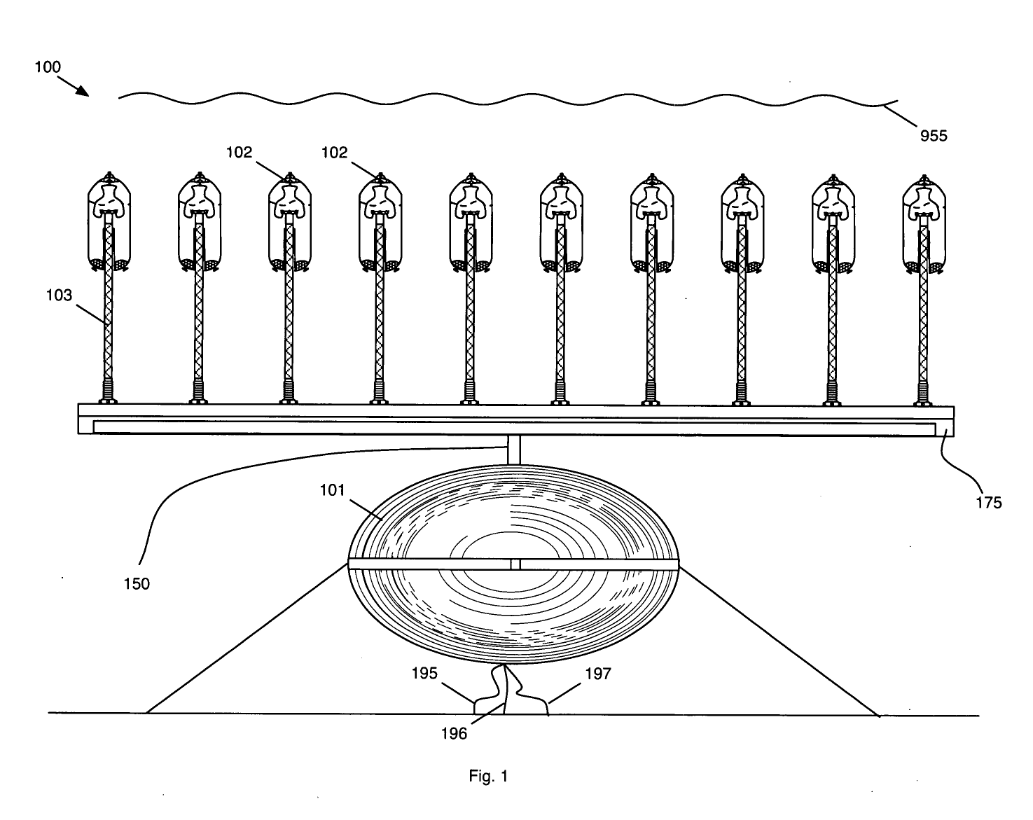

FIG. 1 illustrates a preferred embodiment of the present invention. A Wave Generating System for Converting Ocean Waves into Usable Energy 100 includes a Base 101, a Polyp 102, and a Stem 103. The Polyp 102 is held in position by a large diameter flexible air hose called a Stem 103. The Stem 103 is connected to the Base 101. The Stem 103 prevents drift and supplies the Polyps 102 with air to make buoyancy adjustments. Air is bled from the Base 101 through the Stem 103 and into the buoyancy compensation device when necessary.

In some preferred embodiments the Base 101 may require a mooring design to counter both the upward force and a tendency to tip, which can release gas. The Stem 103 secures the Polyps 102 at the bottom side of passing swells and allows the Polyps 102 to move with cross currents. The Base 101 provides anchorage for the Stems 103 and Polyps 102. The Base 101 also provides first chamber 105, a second chamber 106, and a third chamber 107 for the collection and storage of gases.

It should be noted here that the main purpose of the Base 101 is to provide an anchorage for the purpose of holding the Polyps 102 underneath the passing waves. Without this Base 101, the system would only be operable and feasible in close proximity with the shoreline wherein the depth is optimum. However, since these shallow waters are oftentimes frequented by surfers, fishermen, swimmers etc the use of the system may not be practical. Thus, by providing the Base 101, the Wave Generating System for Converting Ocean Waves into Usable Energy 100 may be operable free from conflict which may be encountered in shallow waters.

The Base 101 is comprised of a plurality of chambers: a first chamber 105, a second chamber 106, and a third chamber 107. In some preferred embodiments, the first chamber 105 may be used to store Hydrogen, the second chamber 106 may be used to store Oxygen, and the third chamber 107 is used for the purpose of imparting buoyancy to the Base 101 and imparting up-lift against mooring lines. The third chamber 107 may also used for the purpose of providing breathable air for operators.

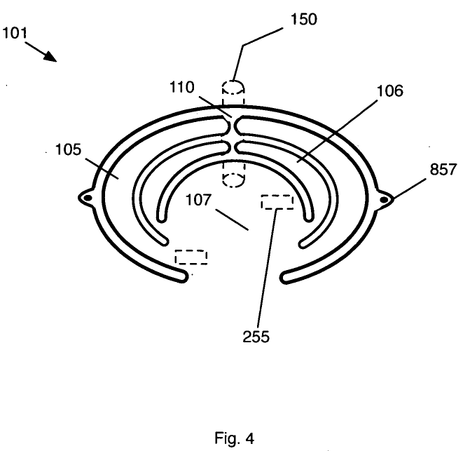

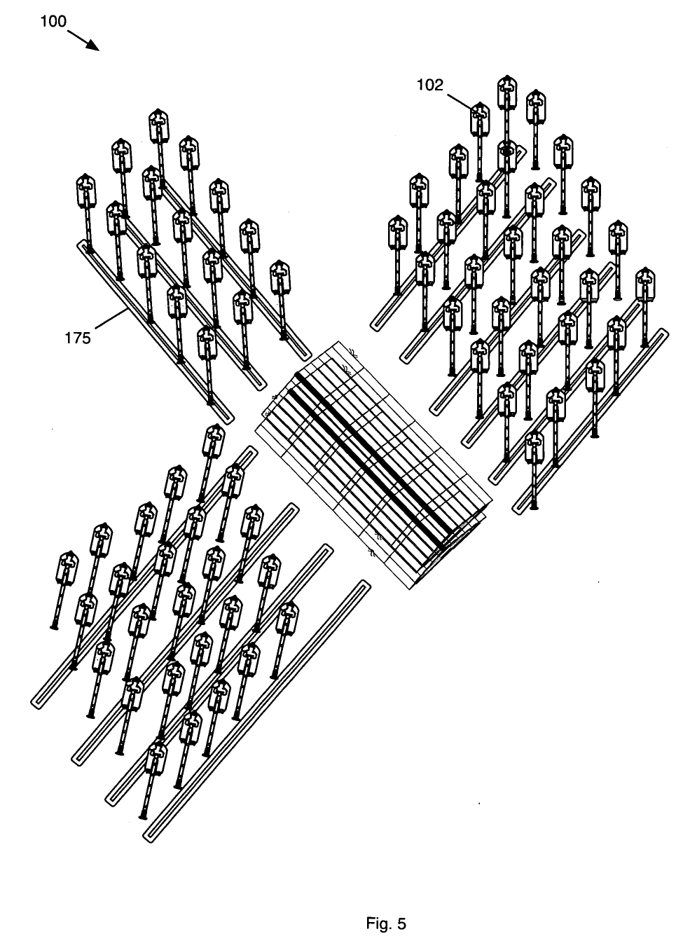

In some preferred embodiments, the Wave Generating System for Converting Ocean Waves into Usable Energy 100 may further comprise a Gas Pump 255 located within the Base 101. FIG. 1 illustrates that in some preferred embodiments, a Hydrogen Line 195, an Oxygen Line 196, and an Air Line 197 may also be included. In other preferred embodiments the Base 101 may alternatively incorporate an air-pumping buoy. In some preferred embodiments the Wave Generating System for Converting Ocean Waves into Usable Energy 100 may comprise a mooring eyelet 857 (illustrated in FIG. 4) for the purpose of anchoring the Base 101 to the sea floor.

FIG. 4 illustrates that in some preferred embodiments, the chambers 105, 106, 107 are partitioned from each other by a central spine 110. The chambers 105, 106, 107 are sealed. In some preferred embodiments the chambers 105, 106, 107 are sealed from each other for the purpose of preventing cross-leakages into each other.

In some preferred embodiments, the Base 101 may be comprised of ferro-cement. In some preferred embodiments the Base 101 may be coated with copper. The copper is added to the finish material to discourage some aquatic. plant and animal life from attaching thereto.

FIG. 3 illustrates through a cross-section view that the Stem 103 is a conduit. The Stem 103 is comprised of a plurality of coiled wire 125 for generating electricity, an air release valve 126 and a ring 127. In some preferred embodiments, the Stem 103 is comprised of an outside liner 353, and an inside liner 351. In the center, the air passage 359 can be viewed from the cross-section view of the Stem 103 in FIG. 3. The Stem 103 holds the Polyp 102 in position beneath waves. The Stem 103 also acts as a conduit down to the Base 101. In some preferred embodiments the Stem 103 is flexible and is comprised of a durable, resilient, and flexible material. In some preferred embodiments, a Flexible Hose 655 is disposed between the Polyp 102 and the Base 101.

The lower ends of these Stems 103 are connected to a main distributor line 175, which is disposed on top of the Base 101. The distributor line 175 provides anchorage and air too many individual polyps in line formation threw these stems. A plurality of distributor lines 175 are connected together and affixed to the upper side of the Base 101.

The Base 101 and distributor lines 175 together act as a manifold to hold many Polyps 102 into a matrix formation. Air is needed to maintain neutral buoyancy of the individual Polyps 102. This arrangement forms a natural flow of air, from the Base 101 through the distributor lines 175, and up through the Stems 103 and into the Polyps 102. The reverse direction concentrates energy downwards to the bottom of the Base 101.

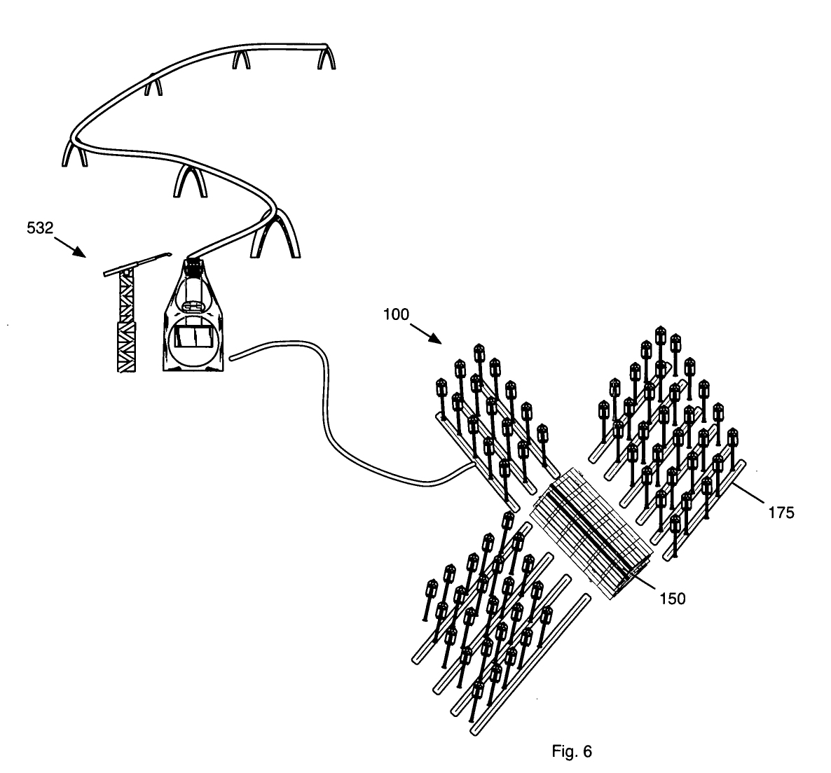

FIG. 1 also illustrates that in some preferred embodiments, the Wave Generating System for Converting Ocean Waves into Usable Energy 100 may further comprise a Conduit System 355. The Conduit System 355 is comprised of a Header 150 and a distributor line 175. The Conduit System 355 allows for the exchange of gases between the Base 101 and the Polyps 102. The Header 150 is the main conduit which interfaces with the Base 101. The gases, in some preferred embodiments may be channeled to a plurality of Polyps 102 through a matrix or grid of distributor lines 175. In some preferred embodiments, each distributor line 175 may interface with an individual Polyp 102 or a series of Polyps 102 arranged in a network, matrix, or grid arrangement as illustrated in FIG. 6.

The Header 150 is an elongate member. The Header 150 is in communication with the Base 101, and the Polyp 102. In some preferred embodiments, the Wave Generating System for Converting Ocean Waves into Usable Energy 100 will further comprise a Beta Valve 155 disposed between the Header 150 and the Stem 103. In some preferred embodiments the Beta Valve 155 may be remote controlled.

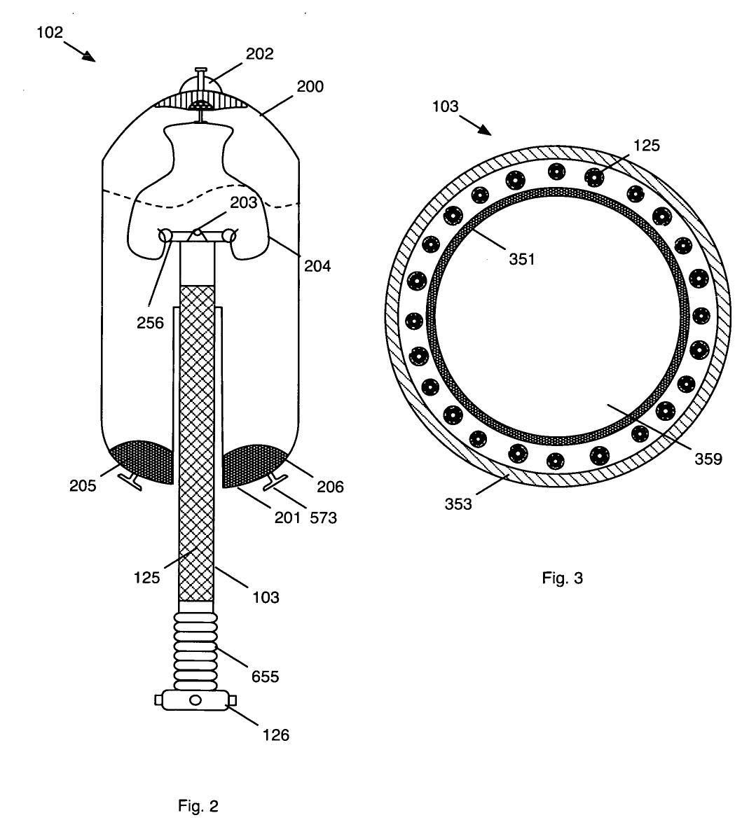

FIG. 2 illustrates that the Polyp 102 is essentially a flexible container with an open bottom. Trapped air at its upper end provides lift and heavy material at its lower end provides ballast. The ballast is provided by at least one magnet 205, 206 which may be donut shaped in some preferred embodiments. The magnets 205, 206 slide easily along the Stem 103.

The Polyp 102 is comprised of a top end 200, and a bottom end 201, an Apex Automatic Air Release Valve 202, an air inlet valve 203, a wire 204, and at least one magnet 205, 206. The wire 204 is connected to the Apex Automatic Air Release Valve 202 and the Stem Bracket 256. In some preferred embodiments, the Polyp 102 includes an Activator 215 to release air from the air inlet valve 203 disposed on the Stem 103. It should be noted here that the Polyp 102 is kept at neutral buoyancy.

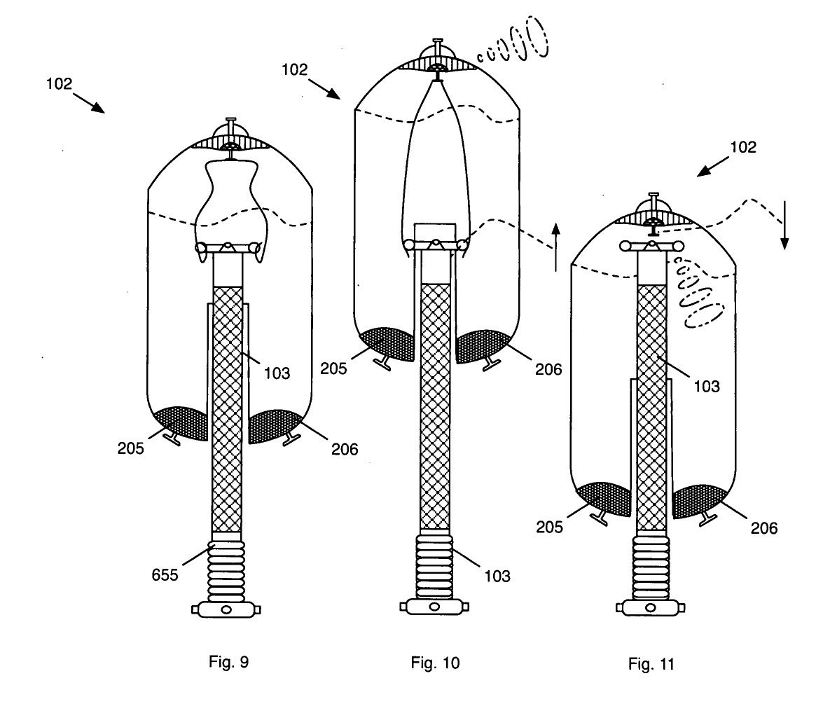

FIGS. 9-11 illustrate that within the Polyp 102 there is an adjustable extension 517 for activating the air inlet valve 203. FIG. 9 illustrates a Polyp 102 in a neutral buoyancy position. FIG. 10 illustrates a Polyp 102 in a positive buoyancy position. When the Polyp 102 is filled with too much air, the Polyp 102 will float in an upwardly direction, which, in turn, will cause the wire 204 to become taut. Consequently, the Apex Automatic Air Release Valve 202 is opened which releases some air to neutralize the buoyancy, and thus, bring about equilibrium. And FIG. 11 illustrates a Polyp 102 in a negative buoyancy position. When the Polyp 102 is in a negative buoyancy position, the Polyp 102 will sink in a downwardly direction. This downwardly movement will activate the air inlet valve 203 on the upper side of the Stem 103. As the air inlet valve 203 is activated, air is released into the Polyp 102, which, in turn, adds lift and will neutralize the buoyancy of the Polyp 102.

The wire 204 is used to actuate the Apex Automatic Air Release Valve 202. The Polyp 102 is a self-adjusting buoyancy-compensating device. The Polyp 102 is airtight to hold an air bubble in its apex to for lift. The energy producing design of the Polyp 102 is based on the back and forth vertical translation actuated by the passing waves 955 above the Polyp 102. As the Polyp 102 vertically translates along the longitudinal axis of the Stem 103, the magnetic fields will cut through the wire 204 coils and produce an electric current without any physical contact.

As illustrated in FIG. 1 the Wave Generating System for Converting Ocean Waves into Usable Energy 100 may comprise a plurality of Polyps 102. The number of Polyps 102 to each Base 101 will be limited by the amount of lift on the Base 101 created by all of the Polyps 102 and their respective Stems 103. Each Polyp 102 is kept at neutral buoyancy and acts as a unit.

Since the Stem 103 is connected to the Base 101, it can be used to routed wires down into the interior of the Base 101. This will allow the Polyp 102 to float free limited only by the hold down wire 204 connected to its Apex Automatic Air Release Valve 202.

As illustrated in FIG. 6 the Wave Generating System for Converting Ocean Waves into Usable Energy 100 may be used in conjunction with a cargo distribution plant 532 for the purpose of supplying energy in the form of hydrogen and oxygen. As part of the cargo distribution plant 532, the Wave Generating System for Converting Ocean Waves into Usable Energy 100 may further comprise in some preferred embodiments an Overhead Rail Network System 539 for transporting cargo.

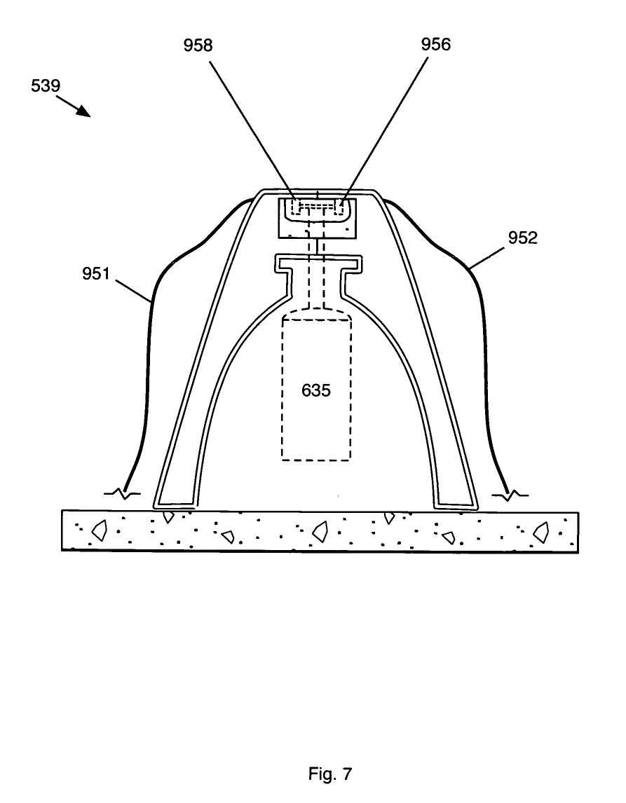

The Overhead Rail Network System 539 may utilize an elevated track system wherein cargo is translated along an elevated track in order to minimize disturbance and encumbrance with various property issues. The Overhead Rail Network System 539 will draw upon energy supplied by the Wave Generating System for Converting Ocean Waves into Usable Energy 100. Moreover, the Overhead Rail Network System 539 may further augment its power requirements through other traditional sources, as well as renewable energy sources such as windmills, solar stations, and the like. FIG. 7 illustrates that the oxygen and the hydrogen is supplied to a cargo loader 539 through gas pipes 951, 952. Cargo 635 is translated vertically by wheels 958, 959.

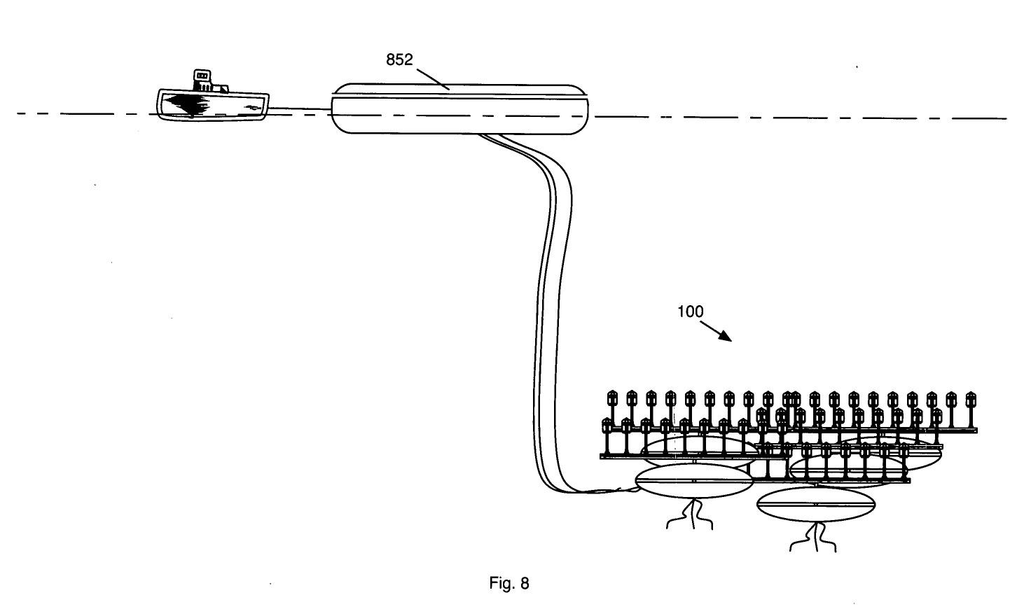

FIG. 8 illustrates that the Wave Generating System for Converting Ocean Waves into Usable Energy 100 may be used in conjunction with a floating data center 852. Hydrogen and oxygen may be supplied to the floating data center 852 by the Wave Generating System for Converting Ocean Waves into Usable Energy 100.

What is claimed is:

1. A Wave Generating System for Converting Ocean Waves into Usable Energy comprising:
a Base, a Polyp, and a Stem;
the Polyp is connected to the Stem;
the Stem is connected to the Base;
the Base is comprised of a plurality of chambers.

2. The Wave Generating System for Converting Ocean Waves into Usable Energy of claim 1 wherein the base is comprised of a first chamber, a second chamber, and a third chamber.

3. The Wave Generating System for Converting Ocean Waves into Usable Energy of claim 1 wherein the Stem is a conduit.

4. The Wave Generating System for Converting Ocean Waves into Usable Energy of claim I wherein the Stem is comprised of a plurality of coiled wire for generating electricity.

5. The Wave Generating System for Converting Ocean Waves into Usable Energy of claim 1 the Stem further comprises an air release valve and a ring.

6. The Wave Generating System for Converting Ocean Waves into Usable Energy of claim 1 wherein the Polyp comprises a top end, and a bottom end, an Apex Automatic Air Release Valve, an air inlet valve, a wire, and at least one magnet;
the wire is connected to the Apex Automatic Air Release Valve and the air inlet valve;
the wire is used to actuate the Apex Automatic Air Release Valve.

7. The Wave Generating System for Converting Ocean Waves into Usable Energy of claim 1 further comprising a Header;
the Header is an elongate member;
the Header is in communication with the Polyp and the base.

8. The Wave Generating System for Converting Ocean Waves into Usable Energy of claim I further comprising an Overhead Rail Network System for transporting cargo.

9. The Wave Generating System for Converting Ocean Waves into Usable Energy of claim I wherein the Overhead Rail Network System for transporting cargo comprises an elevated track.

10. The Wave Generating System for Converting Ocean Waves into Usable Energy of claim 1 further comprising an Overhead Rail Network System for transporting cargo wherein the an Overhead Rail Network System for transporting cargo receives gases for energy use provided by the Wave Generating System for Converting Ocean Waves into Usable Energy.
